(19) United States
(12) Patent Application Publication
(10) Pub. No.: US 2005/0284347 A1
(43) Pub. Date: Dec. 29, 2005

(54) Method of reducing cement kiln NOx emissions by water injection

(75) Inventors: Robin N. Forster, Philadelphia, PA (US); Alexander F. Guyse, King of Prussia, PA (US); Michael I. McCabe, Berwyn, PA (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: Cemex Inc., Houston, TX (US)

(21) Appl. No.: 11/171,963

(22) Filed: Jun. 29, 2005

Related U.S. Application Data
(60) Provisional application No. 60/583,663, filed on Jun. 29, 2004.

(51) Int. Cl. F27B 15/00; F23L 1/00

(52) U.S. Cl. 110/345; 110/297

(57) ABSTRACT

A method and apparatus are disclosed for reducing total NOx emissions from a cement kiln. The method includes the step of injecting water into the flame of the kiln at a point proximate the initial ignition point of the burner. The apparatus includes an injection nozzle for injecting water into the burner flame. Also disclosed is an improved process for making cement clinker. The process includes the steps of burning fuel to generate a flame within a kiln, injecting water into the flame to control formation of nitrogen oxides within the kiln, introducing a mixture of cement raw materials into the kiln, and reacting the raw materials to form cement clinker.

### PRIORITY

This application claims priority to U.S. Provisional Patent Application No. 60/583,663 entitled “Method of Reducing Cement Kiln NOx Emissions by Water Injection” filed on Jun. 29, 2004, which is hereby incorporated by reference in its entirety.

### BACKGROUND OF THE INVENTION

This invention relates to the manufacture of cement, and more particularly to methods for reducing the emissions of nitrogen oxides (NOx) from a cement kiln during operation.

It is well known that in industries employing high-temperature combustion to generate energy, whether for its own sake or to facilitate or accelerate a desired process, a frequent undesirable side effect of such combustion is the generation of nitrogen oxides (“NOx”) that contribute to atmospheric pollution. It has been determined, for example, that NOx emissions (particularly NO₂) react with other atmospheric contaminants to generate ground-level ozone, eye irritants, and photochemical smog. These adverse effects have prompted extensive efforts for controlling NOx emissions to low levels, and a number of processes have been proposed for achieving such control. Among the methods that have been proposed are post-combustion treatment methods such as scrubbing, development of alternative burner designs that inherently produce less NOx, and injection of nitrogen-containing reductants such as ammonia or urea into the reactor to prevent NOx formation or promote NOx decomposition.

It should be apparent that NOx reduction could be achieved by limiting the nitrogen-oxidation reactions that generate NOx. One method of controlling these reactions is to inject water into the combustion chamber, which has the effect of limiting the maximum temperature of the combustion process. The power generation industries have extensively studied the use of water injection for this purpose. For example, U.S. Pat. Nos. 4,600,151; 4,519,769; 4,342,198; 4,337,618; 4,290,558; 4,259,837; 4,160,362; 4,110,973; and 5,784,875 describe the injection of water for the purpose of reducing NOx emissions.

The raw meal for a Portland cement-manufacturing process is formed by grinding and blending calcareous and argillaceous raw materials—a typical mixture comprising 70-90% by weight of limestone, 10-30% by weight of clay, and 0-10% by weight of materials selected to adjust the mixture to the desired composition. The blended raw material then passes through several stages, including:
The drying of the raw materials to remove free water, typically at a temperature upto 100° C.;
the removal of absorbed water, typically at a temperature range of about 100-400° C.;
the decomposition of argillaceous minerals (e.g. kaolinite) to an intermediate stage (e.g. metakaolinite), typically at a temperature range of about 450-750° C.;
the further decomposition from the intermediate stage to free reactive oxides, typically at a temperature range of about 600-900° C.;
the decomposition of carbonates to free reactive oxides, typically at a temperature range of about 600-1000° C.;
the combination of the free reactive oxides to form intermediate or final clinker minerals, typically at a temperature range of about 800-1300° C.;
the formation of clinker melt from aluminates and ferrites, typically at a temperature range of about 1300-1380° C.; and
the formation of alite (C₃S), typically at a temperature range of about 1250-1500° C.
   These chemical reactions are endothermic, with the exception of the combination of free reactive oxides to form intermediate or final clinker materials, which is exothermic. In addition to the C₃S, the other important clinker minerals formed are C₂S, C₃A, and C₄AF.

Burner modifications as employed in the power generation industry may not be directly applicable to the cement manufacturing process as the intensity of combustion and resultant heat transfer profile required within cement kiln for the above reactions is a critical component for obtaining high quality product.

Many of these proposals require expensive equipment or materials, or significant modification of the underlying process, for their implementation. Moreover, there has been limited development of water injection technology for use in cement kilns. Accordingly, there remains a need for further improved processes for control of NOx emissions from cement kilns, particularly if such control can be achieved at relatively low cost. The present invention provides one such improved process whereby NOx emissions can be reduced without adversely affecting product quality.

### SUMMARY OF THE INVENTION

In one aspect, the present invention is a method for reducing total NOx emissions from a cement kiln. The method includes the step of injecting water into the flame of the kiln at a point proximate the initial ignition point of the burner.

In another aspect, the present invention is an apparatus for reducing NOx emissions from a cement kiln. The apparatus includes an injection nozzle for injecting water into the burner flame.

In still another aspect, the present invention is an improved process for making cement clinker. The process includes the steps of burning fuel to generate a flame within a kiln, introducing a mixture of cement raw materials into the kiln, reacting the raw materials to form cement clinker, and injecting water into the flame to control formation of nitrogen oxides within the kiln.

### BRIEF DESCRIPTION OF THE DRAWINGS

The present invention may be better understood by reference to the appended drawings.

FIG. 1 depicts an oil lance suitable for water injection according to the present invention.

FIG. 2 depicts the reduction in NOx emissions observed in a trial of the invention at various water injection rates, as well as the increase in NOx emissions observed when water injection was discontinued.

FIG. 3 depicts the reduction in NOx emissions observed in a series of transitions from no water injection to 5.3 gallons per minute of water.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is intended to cover all modifications, equivalents and alternatives falling within the scope of the invention as defined by the appended claims.

### DESCRIPTION OF ILLUSTRATIVE EMBODIMENTS

An illustrative embodiment of the invention is described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

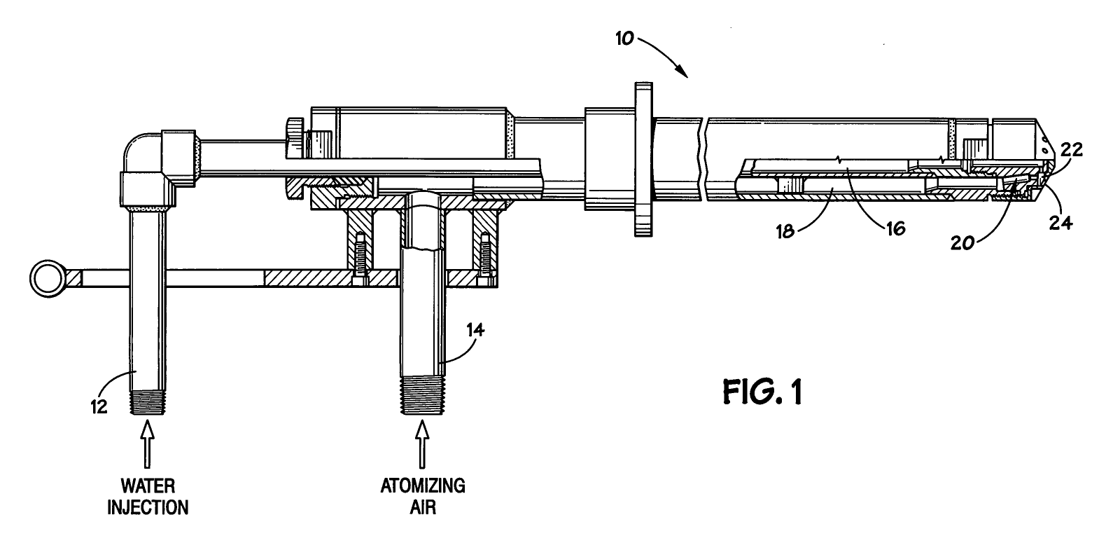

The preferred method of water injection into a cement kiln makes use of the existing capabilities of the burner pipe. For example, the inventors have carried out tests (described below) in which existing oil spray lances (using air atomization) were employed to atomize the water and inject it into the flame. As shown in FIG. 1, water is injected to the spray lance 10 at inlet 12, while the atomizing medium (air in this example) is injected to the spray lance 10 at inlet 14. At the ends of the fluid channel 16 and air channel 18 is a twin annulus atomizing nozzle 20 for primary atomization. The water/air mixture enters the mixing chamber 22 before exiting the spray lance 10 through the outer tip 24.

Alternatively, a water-only spray lance can be inserted into the igniter channel (or any available channel within the pipe). Still another method of positioning the spray lance is to place it outside the burner pipe, with the water spray directed towards the flame. In the case of a non-centrally located igniter channel, it may also be desirable to employ a directional spray nozzle. The water droplet penetration may be controlled by adjusting the direction and momentum of the water spray and the droplet size. One of ordinary skill in the art should appreciate that this, in turn, permits the NOx reduction to be optimized.

A number of variations of the invention will be apparent to those of ordinary skill, of which the following are only representative examples. Water may be injected into the flame via a twin fluid atomizer or a single fluid atomizer designed integral to the burner. In the case of a twin-fluid atomizer, the atomization fluid is water or steam; in the case of the single-fluid atomizer, the fluid is liquid water. Alternatively, water or steam may be injected into the flame via a lance or similar injection system. For example, steam may be injected through a lance that is internal to the burner pipe, or an existing oil spray lance (twin- or single-fluid) may be used for injection of water, with the use of air for atomization if necessary. In yet another embodiment, water or steam may be injected through a lance or similar injection apparatus that is positioned external to the burner pipe. In the latter case, it is preferred that the injector be adapted to provide a directional spray so as to direct the water or steam into the flame.

A further advantage may arise if the water supplied for injection is a component of a mixture that also includes waste fuel (solid or liquid). Ideally such a mixture would contain a high water content, for example about 15% or greater. Under these conditions, the waste fuel adds heating value to the flame while the water content facilitates NOx reduction.

Injection of water would serve as a low cost alternative to NOx scrubbing, a low NOx type burner and urea/ammonia injection. The impact of water introduction to specific fuel consumption should be minimal. This technique is applicable to coal flames, and especially coke flames, where the flame temperature is higher and leads to higher thermal NOx emissions. Thus, fuels that might otherwise be considered unacceptable because of high NOx emissions may be used where water injection is employed to counteract these emissions.

There are at least two distinct approaches for employing the water injection technology in the manufacture of cement. On the one hand, the rapid effect observed as a result of water injection may make this method useful as a fast-acting “quick fix” to counteract short-term increases in NOx emissions. The water injection technology thus helps the cement plant work through a period of high NOx levels without exceeding compliance limits. Once the system is running within normal parameters, water injection can be halted. On the other hand, the method is also suitable for use on a permanent basis as an approved NOx reduction technology on a par with tire injection, low NOx burners and the like.

The following examples are included to demonstrate specific embodiments of the present invention. It should be appreciated by those of skill in the art that the techniques disclosed in the examples which follows represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLE 1

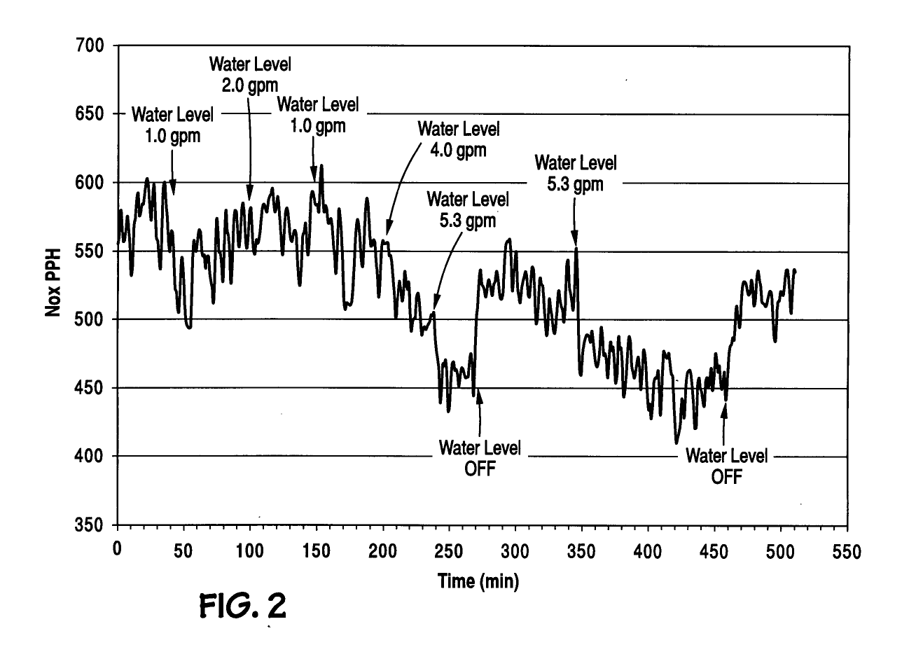

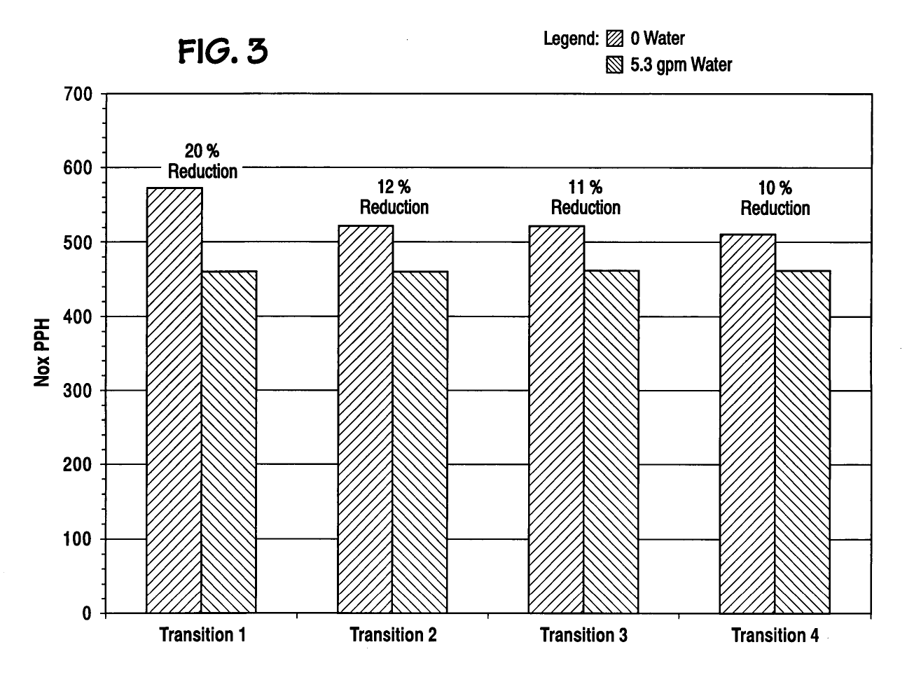

An existing cement kiln operates at 9.5 tons per hour and employs a burner that includes an internal oil lance, permitting direct injection and air atomization of water into the flame. Water was injected into the flame at rates of up to 5.3 gallons per minute (i.e. about 14 weight % water), and the effect on NOx emissions was observed. The results are depicted in FIGS. 2 and 3. With reference to FIG. 2, little effect was noted at water flow rates of 1-2 gpm, although rapid and dramatic reductions in NOx emissions were observed at 4-5.3 gpm. The maximum effect was observed after only a few minutes of water injection. An increase in NOx emissions was also observed when water injection was discontinued (Water Level Off in FIG. 2). FIG. 3 depicts the 10-20% reduction in NOx emissions observed in a series of transitions from no water injection to 5.3 gallons per minute of water injection.

### EXAMPLE 2

A test was conducted to explore the use of petroleum coke as burner fuel for a cement kiln. It had previously been believed that this material could not be used without exceeding NOx emission standards. In a portion of the test, water was injected into the burner via the fuel oil lance at up to 8.5 gallons per minute, which reduced thermal NOx emissions by up to 50%. The use of water injection controlled NOx emissions successfully when coke made up 40 weight % (balance coal) of the burner fuel.

While the invention has been described with reference to the preferred embodiments, obvious modifications and alterations are possible by those skilled in the art. Therefore, it is intended that the present invention include all such modifications and alterations to the full extent that they come within the scope of the following claims or the equivalents thereof.

1. A process for reducing total nitrogen oxide emissions from a cement kiln having a burner at one end thereof, the method comprising the step of injecting water into a flame of the kiln at a point proximate an initial ignition point of the burner.

2. A process according to claim 1, wherein the water is injected in liquid form.

3. A process according to claim 2, wherein the water is injected using an oil spray lance associated with the burner.

4. A process according to claim 2, wherein the water is injected using a dedicated spray lance.

5. A process according to claim 1, wherein the water is injected as steam.

6. A process according to claim 1, wherein the water is injected into the flame from outside the burner.

7. A process according to claim 1, wherein the water is a component of a waste fuel injected into the burner.

8. An apparatus for reducing nitrogen oxide emissions from a cement kiln having a burner at one end thereof, the apparatus comprising an injection nozzle for injecting water into the burner flame.

9. An apparatus according to claim 8, wherein the injection nozzle is also adapted for injecting fuel into the burner.

10. A process for making cement clinker including the steps of:
a) burning fuel in a burner to generate a flame within a kiln;
b) injecting water into the flame to control formation of nitrogen oxides within the kiln; and
c) reacting a mixture of cement raw materials within the kiln to form cement clinker.

11. A process according to claim 10, wherein the water is injected at a point proximate an initial ignition point of the burner.

12. A process according to claim 10, wherein the water is injected in liquid form.

13. A process according to claim 12, wherein the water is injected using an oil spray lance associated with the burner.

14. A process according to claim 12, wherein the water is injected using a dedicated spray lance.

15. A process according to claim 12, wherein the water is a component of a waste fuel injected into the burner.

16. A process according to claim 10, wherein the water is injected into the flame from outside the burner.

17. A process according to claim 10, wherein the water is injected as steam.

18. A process according to claim 10, wherein the fuel is petroleum coke.
